(19) United States
(12) Patent Application Publication
(10) Pub. No.: US 2012/0305613 A1
(43) Pub. Date: Dec. 6, 2012

(54) Automobile console pistol holdster

(76) Inventor: Darryl Lawrence Allen, Phoenix, AZ (US)

(21) Appl. No.: 13/065,699

(22) Filed: Jun. 2, 2011

(51) Int. Cl. B60R 11/00

(52) U.S. Cl. 224/545

(57) ABSTRACT

The Automobile Console Pistol Holster that is made of one piece of injection mold polycarbonate based high impact plastic, molded to the specifications of any weapon. Adjustment screws on the inside are to adjust for snugness. The mold can be changed to replicate any car or truck simply be changing the holster mold or center console mold or both. This holster makes it convenient for access of a pistol instead of being in the glove box, in the armrest, under the seat or on your side, as well as remaining safe and perfectly legal. This holster places the pistol at a finger tips reach.

### BRIEF DESCRIPTION OF THE DRAWINGS

FIG. 1 is a view showing the outside of the molded holster as well as places for cups showing the entrance of the holster from the passenger side view; pistol would be inserted barrel first like a normal plastic holster that can be form fitted for any automatic or revolver.

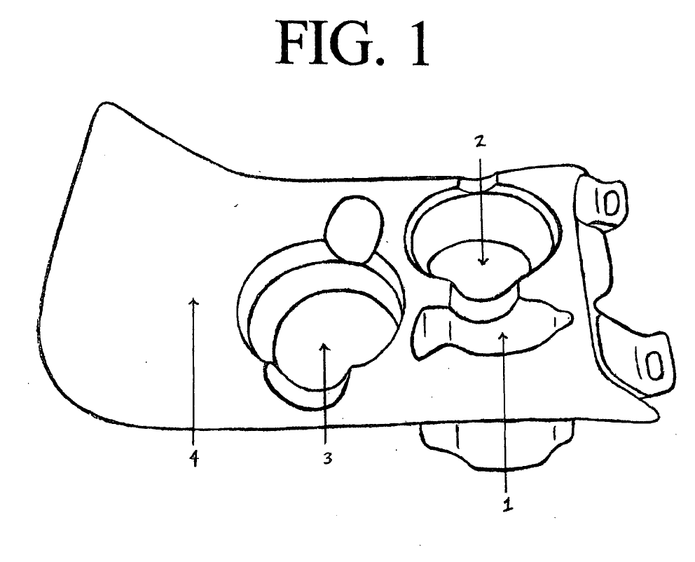

FIG. 2 is a view showing the bottom inside of the center console; including where the snapping mechanism; rubber grommets and screw are located for the adjustments of the holster; as well as showing that the holster is an actual holster.

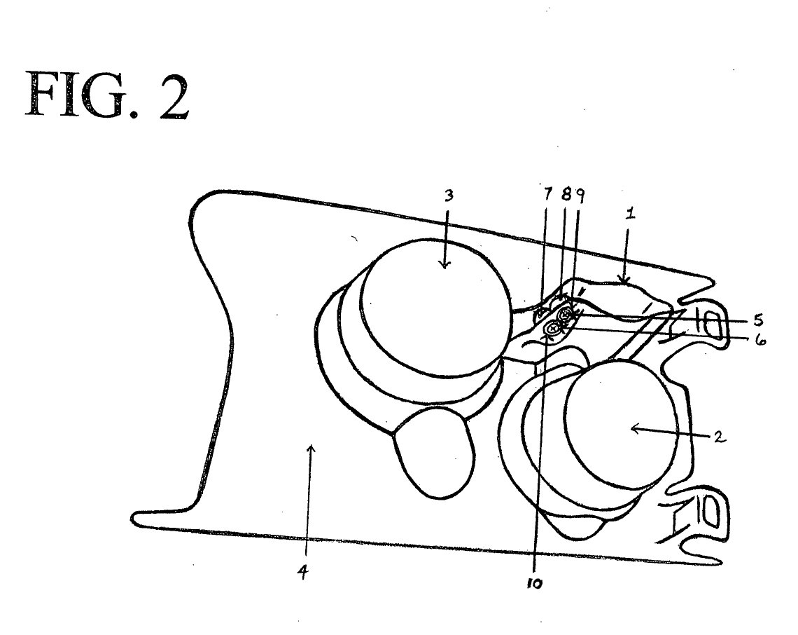

### SPECIFICATIONS

1 The Console Pistol Holster comprise an anchored elongate means having a bight formed therein at the upper end of said solid means for supporting and affixing pistol adjustment screws; said screws being sized to be threaded and comprised of a criss cross screw driver pattern flat headed cap screw with finishing washers as a means of adjustment with rubber spacers also with threaded self anchoring stand offs attached on opposite side that match threads on the screws as mean to draw the holster opening closed for the purposes tightening as desired as well as the holster being in a one piece mold into the center console of a vehicle which allows the pistol to snap into holster by merely applying downward pressure and removal by applying the opposite negative pressure by pulling the pistol grip also trigger is hidden inside holster while in storage position. The Console Pistol Holster is attached in different mean of different types of vehicles; composed of screws to lock the Center Console Pistol Holster in it's place.

2 The Center Console Pistol holster of claim 1 wherein said mold is one piece and will be molded differently for different types of vehicles.

3 The Center Console Pistol Holster of claim 1 wherein said is molded out of Polly carbonate high strength plastic that is scuff resistant as well as locking pistol by securing the front of the trigger guard.

4 The Center Console Pistol Holster of claim 3 including mounted fastener means securing of the piece into vehicle in normal position.

5 The Center Console Pistol Holster of claim 4 including a different means of fastening that will be pre-molded considering the different types of vehicle.

6 The Center Console Pistol Holster comprising an adjustment screws and planetary nuts that is means for the nut does not spin while adjustments are being made anchored to plastic by means of spikes in bedded into surface of plastic; as well as washers to allow screw to freely spin for tightening purposes as with rubber spacers to maintain proper distance as well as having space around adjustment screws.

7 The Center Console Pistol Holster of claim 5 wherein said molded plastic is as well can be molded for any type of pistol capable of fitting by all means of any one person's use as well as area; or positioned side from right to left.

8 The Center Console Pistol Holster of claim 7 including positioning for accessibility for any one person's convenience.

I claim that

1. A Console Pistol Holster comprise an anchored elongate means having a bight formed therein at the upper end of said solid means for supporting and affixing pistol adjustment screws; said screws being sized to be threaded and comprised of a criss cross screw driver pattern as a means of adjustment with rubber spacers also with threaded anchor attachments; that match threads on the screws as mean to draw the holster opening closer for a tightening purposes as well as the holster being in a one piece mold into the center console of a vehicle which allows the pistol to snap into holster by merely applying downward pressure and removal by applying the opposite negative pressure by merely pulling the pistol grip; trigger is hidden inside holster while in storage position and can be installed in different types of vehicles; composed of screws to lock the Center Console Pistol Holster in it's place:
The Center Console Pistol Holster of claim 1 wherein said mold is one piece and will be molded differently for different types of vehicles.
The Center Console Pistol Holster of claim 1 wherein said is molded out of Polly carbonate high strength plastic that is scuff resistant as well as locking pistol by securing the front of the trigger guard.
The Center Console Pistol Holster of claim 3 including mounted fastener means securing of the piece into vehicle in normal position.
The Center Console Pistol Holster of claim 4 including a different means of fastening that will be pre-molded considering the different types of vehicle.
The Center Console Pistol Holster comprising an adjustment screws and planetary nuts that is means for the nut does not spin while adjustments are being made anchored to plastic by means of spikes in bedded into surface of plastic; as well as washers to allow screw to freely spin for tightening purposes as with rubber spacers to maintain proper distance as well as having space around adjustment screws.
The Center Console Pistol Holster of claim 5 wherein said molded plastic is as well can be molded for any type of pistol capable of fitting by all means of any one person's use as well as area; or positioned side from right to left.
The Center Console Pistol Holster of claim 7 including positioning for accessibility for any one person's convenience.
